(19) United States
(12) Patent Application Publication
(10) Pub. No.: US 2025/0139984 A1
(43) Pub. Date: May 1, 2025

(54) METHOD, DEVICE, AND COMPUTER PROGRAM PRODUCT FOR THREAT NOTIFICATION

(71) Applicant: Dell Products L.P., Round Rock, TX (US)

(72) Inventors: Bin He, Shanghai (CN); Jiacheng Ni, Shanghai (CN); Wenlei Wu, Shanghai (CN); Zhen Jia, Shanghai (CN)

(21) Appl. No.: 18/521,026

(22) Filed: Nov. 28, 2023

(30) Foreign Application Priority Data
Oct. 27, 2023 (CN) 202311415230.X

(51) Int. Cl. G06V 20/58; G06T 7/20; G08G 1/16

(52) U.S. Cl. CPC G06V 20/58; G06T 7/20; G08G 1/162; G06T 2207/20021; G06T 2207/30241; G06T 2207/30261

(57) ABSTRACT

The present disclosure relates to a method, a device, and a computer program product for threat notification. The method includes receiving an image indicating a first object, wherein the first object includes at least one of a vehicle and a vulnerable road user (VRU). The method further includes detecting a first threat associated with the first object based on processing of the image, and sending, in response to detection of the first threat, a notification about the first threat to at least one of the first object and a second object associated with the first object. In this way, once a threat is detected, a notification can be sent only to a specific road participant such as the first object and the second object, so that the notification can be sent and processed more accurately, and less bandwidth is used, thereby improving the communication efficiency.

### RELATED APPLICATION

The present application claims priority to Chinese Patent Application No. 202311415230.X, filed Oct. 27, 2023, and entitled “Method, Device, and Computer Program Product for Threat Notification,” which is incorporated by reference herein in its entirety.

### FIELD

The present application relates to the field of intelligent transportation, and more specifically, to a method, a device, and a computer program product for threat notification.

### BACKGROUND

Multi-access edge computing (MEC) is a concept promulgated by the European Telecommunications Standards Institute (ETSI) to apply edge computing to mobile communication networks. The MEC aims to support the development of mobile use cases for edge computing, which allows application developers and content providers to access computing power and IT service environments in dynamic settings at the edge of a network. The ETSI MEC industry specification group (ISG) provides four types of use cases for intelligent transportation systems: safe, convenient, advanced driving assistance, and vulnerable road user (VRU). Among these use cases, VRUs including pedestrians and riders (such as cyclists, electric bicycle riders, and motorcycle riders) are considered one of the key use cases, due to the fact that over 50% of all road traffic deaths involve VRUs. Therefore, it is important to detect threats related to VRUs and send notifications to other road participants, so that other road participants have sufficient time to respond.

### SUMMARY

Embodiments of the present disclosure provide a method, a device, and a computer program product for threat notification. In embodiments of the present disclosure, an image indicating a first object may be received, a first threat may be detected based on processing of the image, and in response to detection of the first threat, a notification about the first threat may be sent to the first object or a second object associated with the first object. In this way, once a threat is detected, a notification can be sent only to a specific road participant (such as the first object and the second object associated with the first object) in a scenario, so that the notification can be sent and processed more accurately. Moreover, since the notification is only sent to the specific road participant, less bandwidth is used, thereby improving the communication efficiency.

In a first aspect of embodiments of the present disclosure, a method for threat notification is provided. The method includes receiving an image indicating a first object, wherein the first object includes at least one of a vehicle and a VRU. The method further includes detecting a first threat associated with the first object based on processing of the image, and sending, in response to detection of the first threat, a notification about the first threat to at least one of the first object and a second object associated with the first object.

In a second aspect of embodiments of the present disclosure, an electronic device is provided. The electronic device includes at least one processor; and a memory coupled to the at least one processor and having instructions stored therein, wherein the instructions, when executed by the at least one processor, cause the electronic device to perform actions including: receiving an image indicating a first object, wherein the first object includes at least one of a vehicle and a VRU. The actions further include detecting a first threat associated with the first object based on processing of the image, and sending, in response to detection of the first threat, a notification about the first threat to at least one of the first object and a second object associated with the first object.

In a third aspect of embodiments of the present disclosure, a computer program product is provided. The computer program product is tangibly stored on a non-transitory computer-readable medium and includes machine-executable instructions, wherein the machine-executable instructions, when executed by a machine, cause the machine to perform actions including: receiving an image indicating a first object, wherein the first object includes at least one of a vehicle and a VRU. The actions further include detecting a first threat associated with the first object based on processing of the image, and sending, in response to detection of the first threat, a notification about the first threat to at least one of the first object and a second object associated with the first object.

It should be understood that the content described in this Summary is neither intended to limit key or essential features of embodiments of the present disclosure, nor intended to limit the scope of the present disclosure. Other features of embodiments of the present disclosure will become readily understood from the description herein.

### BRIEF DESCRIPTION OF THE DRAWINGS

The above and other features, advantages, and aspects of embodiments of the present disclosure will become more apparent with reference to the accompanying drawings and the following Detailed Description. In the accompanying drawings, identical or similar reference numerals represent identical or similar elements, in which:

FIG. 1 shows a schematic diagram of an example system in which a plurality of embodiments of the present disclosure may be implemented;

FIG. 2 shows a schematic diagram of a process for threat notification according to some embodiments of the present disclosure;

FIG. 3 shows a flow chart of a method for threat notification according to some embodiments of the present disclosure;

FIG. 4 shows a schematic diagram illustrating an implementation of a process for threat notification in a first application scenario according to some embodiments of the present disclosure;

FIG. 5 shows a schematic diagram of zone division and corresponding driving strategies in a first application scenario according to some embodiments of the present disclosure;

FIG. 6 shows a schematic diagram illustrating an implementation of a process for threat notification in a second application scenario according to some embodiments of the present disclosure;

FIG. 7 shows a schematic diagram of another application scenario in which threat notification is implemented according to some embodiments of the present disclosure;

FIG. 8 shows a schematic diagram of a process of detecting objects in an image and performing hierarchic classification on the objects according to some embodiments of the present disclosure;

FIG. 9A and FIG. 9B respectively show schematic diagrams of processes for object detection and for marking an identity (ID) of an object in an image according to some embodiments of the present disclosure;

FIG. 10 shows a schematic diagram of a process for mapping an ID of an object in an image to an ID of the object in a communication layer according to some embodiments of the present disclosure;

FIG. 11 shows a flow chart of another method for threat notification according to some embodiments of the present disclosure; and

FIG. 12 shows a block diagram of a device that may implement a plurality of embodiments of the present disclosure.

### DETAILED DESCRIPTION

Illustrative embodiments of the present disclosure will be described below in further detail with reference to the accompanying drawings. Although the accompanying drawings show some embodiments of the present disclosure, it should be understood that the present disclosure may be implemented in various forms, and should not be construed as being limited to the embodiments stated herein. Rather, these embodiments are provided for understanding the present disclosure more thoroughly and completely. It should be understood that the accompanying drawings and embodiments of the present disclosure are for exemplary purposes only, and are not intended to limit the scope of protection of the present disclosure.

In the description of embodiments of the present disclosure, the term “include” and similar terms thereof should be understood as open-ended inclusion, that is, “including but not limited to.” The term “based on” should be understood as “based at least in part on.” The term “an embodiment” or “the embodiment” should be understood as “at least one embodiment.” The terms “first,” “second,” and the like may refer to different or identical objects. Other explicit and implicit definitions may also be included below.

Cellular Vehicle-to-Everything (C-V2X) is commonly used to detect threats and send notifications to vehicles. C-V2X is an interconnected mobile platform that allows vehicles to interact with a surrounding environment (such as pedestrians, vehicles, road basic setup, and networks) using a cellular network.

However, conventional C-V2X typically utilizes, for example, a 5G network to send a threat related notification using a broadcast or multicast protocol in a communication layer, which is based on cell coverage, that is, sends the same notification to all road participants within the cell. Distinguishable broadcast messages may confuse unrelated users. One solution may use scrambling codes to distinguish different OEM manufacturers, but such an arrangement may not determine which specific vehicle in which lane should receive a message. These two notification sending methods are not precise enough to send relevant notifications to specific road participants. Therefore, a more precise notification sending scheme is needed.

As used herein, the road participants include various types of vehicles and VRUs.

Therefore, embodiments of the present disclosure provide a solution for threat notification. In embodiments of the present disclosure, an image indicating a first object may be received, wherein the first object includes at least one of a vehicle and a VRU. A first threat associated with the first object may further be detected based on processing of the image, and in response to detection of the first threat, a notification about the first threat may be sent to at least one of the first object and a second object associated with the first object.

In this way, threat detection is based on a specific first object, and once a threat is detected, a notification is sent only to at least one of the first object and the second object associated with the first object in the scenario, so that the notification can be sent to a specific road participant more accurately. For example, for a possible right turn collision of a vehicle, a notification related to the right turn collision may only be sent to a VRU located near the right front of the vehicle or a vehicle in a right turn lane, without the need to be sent to a vehicle in a left lane of the vehicle. By sending the notification only to a specific object, bandwidth occupation may be reduced, thereby improving the communication efficiency.

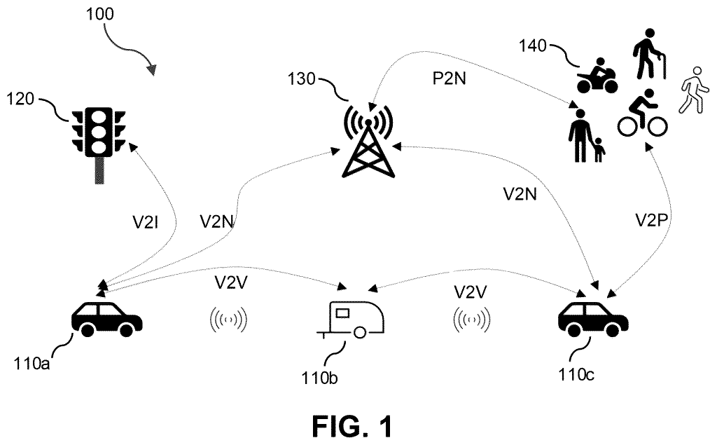

FIG. 1 shows a schematic diagram of an example C-V2X system 100 in which a plurality of embodiments of the present disclosure may be implemented. As shown in FIG. 1, the C-V2X system 100 includes vehicles 110a to 110c (collectively referred to as a vehicle 110), a road basic setup 120, a network (or a base station) 130, and a pedestrian (or a VRU) 140. For example, the vehicle 110 may include various types of motor vehicles, such as cars, trucks, and engineering vehicles. For example, the road basic setup 120 may include a traffic light, a roadside unit (RSU), and the like. For example, the pedestrian 140 may include a rider, such as a cyclist, a motorcycle rider, and an electric bicycle rider. It should be noted that in the present disclosure, the pedestrian and the VRU have the same meaning and are interchangeable. In the C-V2X system 100, the vehicle 110 may be connected to the road basic setup 120, the network 130, and the VRU 140 through cellular connections. These connections may be divided into four types: V2V (vehicle to vehicle), V2I (vehicle to infrastructure, also referred to herein as “road basic setup”), V2P (vehicle to pedestrian), and V2N (vehicle to network), wherein V2X encompasses any or all of these connections. Other types of connections illustrated in the figure include P2N (pedestrian to network).

As shown in FIG. 1, the vehicle 110 or the road basic setup 120 may capture image data. When any one of the vehicle 110 and the VRU 140 exists in the image, the image is transmitted to an electronic device. In some embodiments, the electronic device may be located at a near edge. In other embodiments, the electronic device may be located at a far edge. In an edge computing architecture, the near edge is closer to a data processing center (or cloud), while the far edge is farther away from the data processing center (or cloud).

The electronic device receives the image indicating any one of the vehicle 110 and the VRU 140. The electronic device may further detect, based on processing of the image, a threat associated with any one of the vehicle 110 and the VRU 140. In some embodiments, the threat associated with any one of the vehicle 110 and the VRU 140 may include a road safety threat caused by the vehicle 110 or the VRU 140. In other embodiments, the threat associated with any one of the vehicle 110 and the VRU 140 may also include a road threat caused by another road participant or another object to the vehicle 110 or the VRU 140. In some embodiments, the threat detection may include: detecting that the vehicle 110 or the VRU 140 is located in a specific zone, such as in an emergency stop area; detecting that the vehicle 110 and the VRU 140 are in a specific relative location, such as being close in a specific direction, and thus having a collision risk; or detecting a change in a movement state of the vehicle 110 or the VRU 140, such as exceeding a safe speed, sudden deceleration, sudden braking, turning, or falling of a pedestrian or cyclist. In other embodiments, the threat detection may include detecting another road participant who poses a potential threat to the vehicle 110 and the VRU 140, such as a speeding vehicle or a large vehicle, and the large vehicle is, for example, an engineering vehicle, a heavy truck, or the like. The electronic device may also send, in response to detection of a threat, a notification about the threat to the vehicle 110 or the VRU 140 or another road participant associated with the vehicle 110 or the VRU 140.

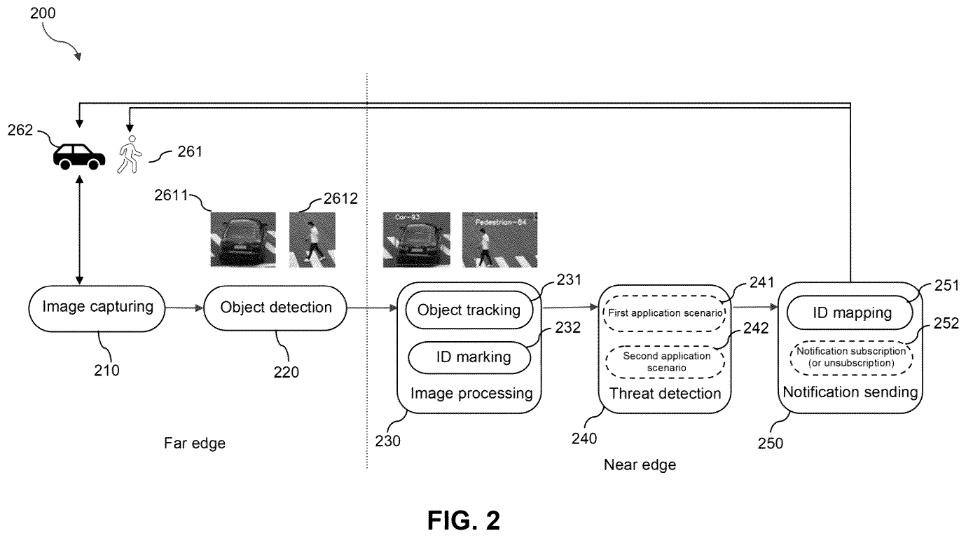

FIG. 2 shows a schematic diagram of a process 200 for threat notification according to some embodiments of the present disclosure. As shown in FIG. 2, the process 200 includes receiving an image indicating a first object 261, wherein the first object 261 includes at least one of a vehicle 2611 and a VRU 2612. After image capturing at block 210 and object detection at block 220, the process 200 further includes processing the image at block 230, and detecting, at block 240, a first threat associated with the first object 261 based on the processing of the image at block 230. The process 200 further includes sending a notification (or message) about the first threat to at least one of the first object 261 or a second object 262 associated with the first object 261 at block 250.

It should be understood that in embodiments of the present disclosure, the first object 261 is depicted as a VRU and the second object 262 is depicted as a vehicle, which is only an example, but the present disclosure is not limited to this. Both the first object 261 and the second object 262 may be any one of a vehicle or a VRU, and both may be vehicles or VRUs.

As shown in FIG. 2, in some embodiments, the processing of the image at block 230 includes tracking the first object 261 at block 231 to determine trajectory data of the first object 261, wherein the trajectory data may include the location, speed, and traveling direction of the first object 261. In some embodiments, the image may include a plurality of consecutive image frames (an image set), and the plurality of image frames are processed to determine the trajectory data of the first object 261. In some embodiments, the trajectory data may be used for short-term location prediction. In some embodiments, at block 231, it may further include classifying the first object 261 to track the first object 261 of a specific type.

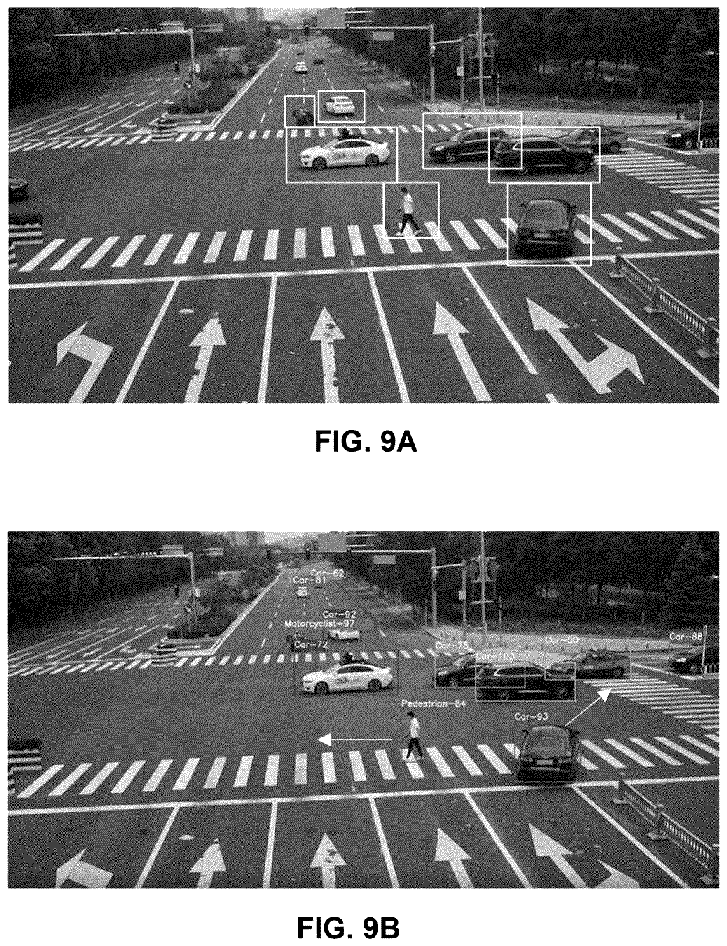

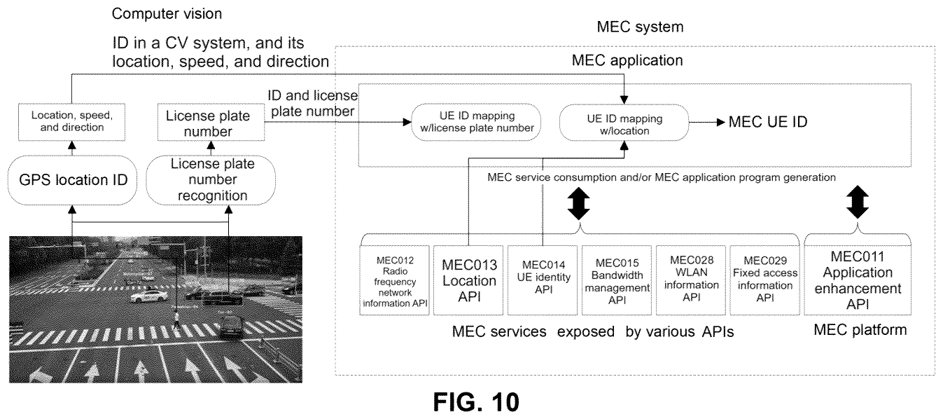

As shown in FIG. 2, in some embodiments, the processing of the image further includes marking an ID of the first object 261 in the image at block 232. In some embodiments, sending the notification about the first threat to at least one of the first object 261 or the second object 262 associated with the first object 261 includes, at block 251, mapping the ID of the first object 261 in the image to an ID of the first object 261 in a communication layer (or transmission layer), and sending, based on the mapping, the notification about the first threat to at least one of the first object 261 and the second object 262. In some embodiments, the ID of the first object 261 in the communication layer is obtained by retrieving a user equipment (UE) ID from an MEC system. In some embodiments, the ID mapping at block 251 establishes a connection between an application layer (the object ID marked in the image) and the transmission layer (the UE ID retrieved from the MEC system), and a set of methods may be used to synthesize the mapping between the two layers. The processes of detecting the first object 261 in the image and marking the ID of the first object 261 in the image will be described in detail with reference to FIG. 9A and FIG. 9B, and the process for mapping between IDs will be described in detail with reference to FIG. 10.

In some embodiments, detecting the first threat at block 240 includes detecting the first threat in a plurality of application scenarios associated with a movement state of the object and a surrounding environment. In some embodiments, detecting the first threat associated with the first object 261 may include determining, for corresponding application scenarios, potential threats to the VRU by using different urgency degrees and response times, and notifications about the first threat may be classified into corresponding notification types, such as a presence notification for early altering and collision warning for a potential immediate collision.

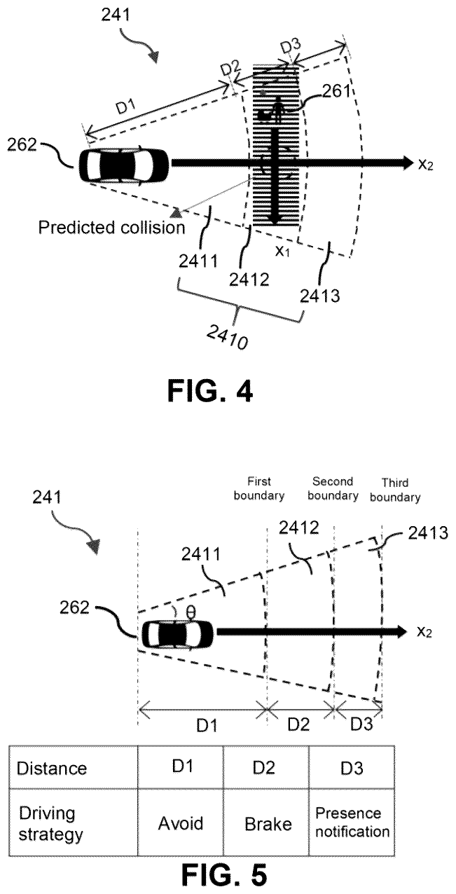

In some embodiments, detecting the first threat at block 240 includes determining, in a first application scenario 241, a first zone where the first threat exists, and the first zone is associated with the second object 262. In some embodiments, the first zone is in the traveling direction of the second object 262 and is a sector-shaped zone centered on the second object 262. In some embodiments, the first zone is a collision zone. The threat detection process associated with the first application scenario 241 will be described in detail with reference to FIG. 4 and FIG. 5.

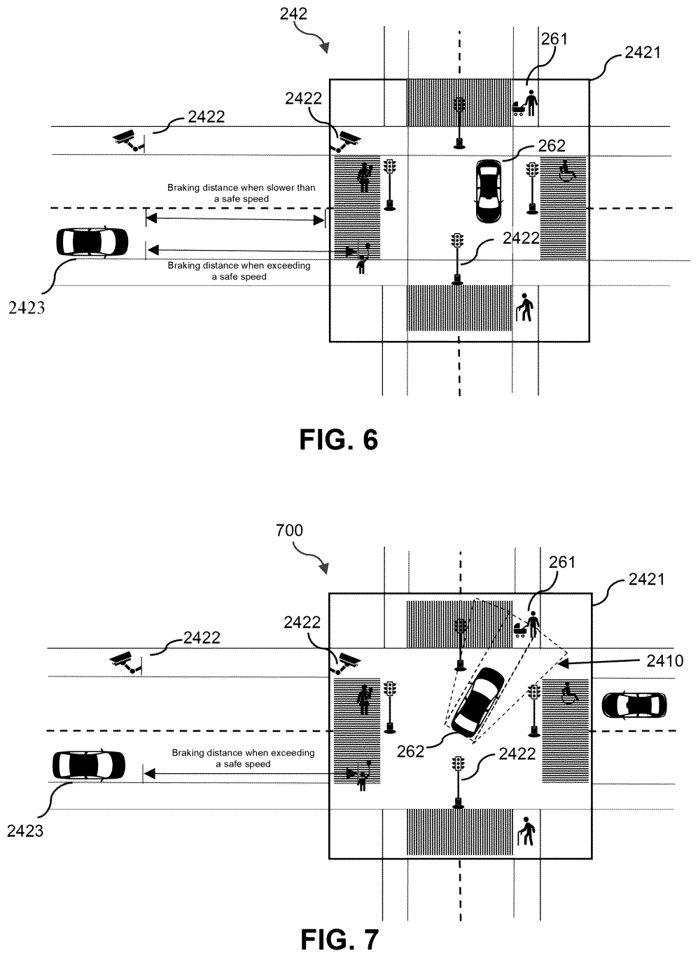

In some embodiments, the detection of the first threat at block 240 includes determining, in a second application scenario 242, a second zone associated with the road, wherein the second zone has the first threat indicating a threatening road participant. In some embodiments, the second zone is a monitoring zone. In some embodiments, the first threat includes at least one of a large vehicle and a speeding vehicle. The threat detection process associated with the second application scenario 242 will be described in detail with reference to FIG. 6.

In some embodiments, sending the notification at block 250 may include subscribing to (or unsubscribing from) the notification at block 252. In one embodiment, the subscribing to or unsubscribing from the notification may be performed actively by the road participant. In another embodiment, subscribing to the notification may be passive, such as automatically subscribing to the notification when the road participant enters a specific zone, and automatically unsubscribing from the notification when he/she leaves the specific zone. In some embodiments, messages may be sent to specific objects in the form of unicast or multicast for different application scenarios or zones. In some embodiments, when vehicles or VRUs enter a related zone, they will automatically book to the MEC system for related message filtering and cancel the booking when leaving the zone. In some embodiments, a message queue will be maintained for message distribution, and messages will be destroyed after a certain period of time. In some embodiments, the process of the blocks 230, 240, and 250 may be performed at the near edge.

In one embodiment, the process 200 may receive an image from the far edge, and the image is preprocessed to indicate the first object 261. As shown in FIG. 2, in some embodiments, the process 200 includes capturing the image at block 210. In some embodiments, the image may be captured by a sensor of the second object 262. In other embodiments, the image may be captured by an RSU, and the RSU may include any device capable of capturing road data, such as a camera, a closed-circuit television system (CCTV), intelligent transportation, or radar. In some embodiments, the captured image at block 210 may be executed at the far edge.

In some embodiments, the image is preprocessed to indicate that the first object 261 includes detecting objects in the image. As shown in FIG. 2, in some embodiments, the process 200 includes performing object detection at block 220 to determine the presence of the first object 261 in the image. In some embodiments, the object detection at block 220 may be performed at the far edge. In some embodiments, once the presence of the first object 261 is detected in the image, the image is sent to the near edge for processing the image at block 230. In some embodiments, the far edge may detect moving objects, such as vehicles and pedestrians, in images associated with intersections or other zones. If an object is detected, a VRU is triggered to detect the scenario, and then the captured image data is sent to the near edge for image processing. In some embodiments, the image may be cropped to remove irrelevant zones in the image to optimize the computational performance and save the transmission bandwidth.

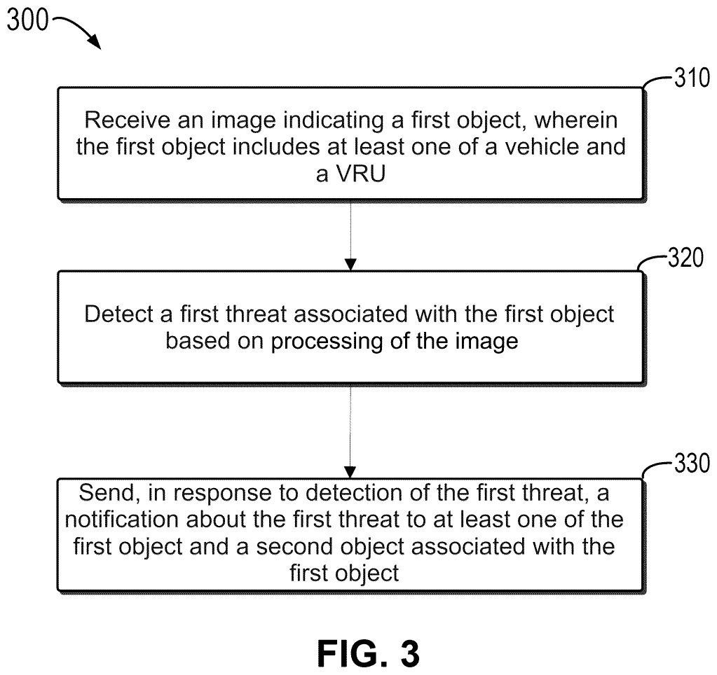

FIG. 3 shows a flow chart of a method 300 for threat notification according to some embodiments of the present disclosure. As shown in FIG. 3, at block 310, the method 300 receives an image indicating a first object, wherein the first object includes at least one of a vehicle and a VRU. For example, in the process 200 shown in FIG. 2, the method 300 may, after the presence of the first object in the image is determined at block 220, receive the image indicating the first object, and process the image at block 230.

At block 320, the method 300 detects a first threat associated with the first object based on the processing of the image. For example, in the process 200 shown in FIG. 2, the method 300 may detect the first threat associated with the first object at block 240 based on the trajectory data of the first object obtained by processing the image at block 230.

At block 330, the method 300 sends, in response to detection of the first threat, a notification about the first threat to at least one of the first object and a second object associated with the first object. For example, in the process 200 shown in FIG. 2, the method 300 may send, in response to detection of the first threat at block 240, the notification about the first threat to the first object 261 or the second object 262 at block 250. In this way, once the threat is detected, the notification may only be sent to specific road participants in the scenario (such as the first object and the second object associated with the first object), so that the notification can be sent and processed more accurately, and less bandwidth is used, thereby improving the communication efficiency.

FIG. 4 shows a schematic diagram illustrating an implementation of a process for threat notification in a first application scenario 241 according to some embodiments of the present disclosure. In the process, in the first application scenario 241, a first zone (collision zone) 2410 having the first threat is determined, and the first zone 2410 is associated with the second object 262. The first zone 2410 is in a traveling direction x2 of the second object 262 and is a sector-shaped zone centered on the second object 262.

As shown in FIG. 4, in some embodiments, the first object 261 is a VRU with a traveling direction x₁, and the second object 262 is a vehicle with the traveling direction x₂. In some embodiments, the first zone 2410 is the collision zone, where a collision may occur between the vehicle and the VRU based on current movement trends thereof, that is, a threat associated with the first object 261 is detected. For example, as shown in FIG. 4, a collision may occur at an intersection of the traveling direction x₁ of the VRU and the traveling direction x₂ of the vehicle. In some embodiments, the first zone 2410 is a sector-shaped zone centered on the second object 262, and using a relatively wide sector-shaped zone instead of a linear shape can perceive a wider zone for early warning, and is more effective especially in zones with obstacles. As shown in FIG. 4, in addition to covering the field of view in front of the vehicle, the first zone 2410 will also cover a small part of the rear field of view and side fields of view of the vehicle, as vehicles should approach their VRUs carefully and avoid accidents caused by urgency braking, turning, towing (pulling over), and even door opening. In one example, the C-V2X system may utilize a sensor and computer vision to achieve non-line-of-sight perception for VRU discovery.

In some embodiments, a notification about a potential collision is sent to the first object 261 or the second object 262. For example, the notification may be sent not only to vehicles, but also to VRUs, which can prevent traffic accidents caused by the VRUs looking at their phones while walking or riding, thereby providing protection for the VRUs. For example, the notification may be sent to wearable devices of the VRUs for easy viewing, which may notify the VRUs faster than mobile phones do. It should be understood that although the first object 261 is shown as a VRU in FIG. 4, it may also be a vehicle.

FIG. 5 shows a schematic diagram of zone division and corresponding notification or driving strategies in a first application scenario 241 according to some embodiments of the present disclosure. In some embodiments, the first zone 2410 is divided into a plurality of sub-zones based on a distance from the second object 262, and sending the notification about the first threat to at least one of the first object 261 and the second object 262 associated with the first object 261 includes: sending the corresponding notification to the first object 261 according to a detection that the first threat is in the corresponding sub-zone. In some embodiments, different driving strategies may be adopted for notifications of different urgency levels.

In some embodiments, the plurality of sub-zones include a first sub-zone 2411, a second sub-zone 2412, and a third sub-zone 2413, and a distance from a boundary between the first sub-zone 2411 and the second sub-zone 2412 to the second object 262 is determined based on a braking distance of the second object 262, and a distance from a boundary between the second sub-zone 2412 and the third sub-zone 2413 to the second object 262 is determined based on a speed and a reaction time of the second object 262. In some embodiments, the second object 262 is a vehicle, and the distance from the boundary between the first sub-zone 2411 and the second sub-zone 2412 to the vehicle is D1. D1 is equal to the braking distance of the vehicle, that is, D1=v²/\sqrt{2 μg}, wherein v is the speed of the vehicle, μ is the friction coefficient, and g is the gravitational acceleration. In some embodiments, the distance from the boundary between the second sub-zone 2412 and the third sub-zone 2413 to the vehicle is s, s=n*v, wherein v is the speed of the vehicle, and n is the reaction time of the driver. In some embodiments, n may be 2s to 4s. In some embodiments, v may be equal to an average speed of the vehicle in a period of time or a plurality of consecutive image frames. In some embodiments, as shown in FIG. 5, an angle between a boundary of the sector-shaped first zone 2410 and the vehicle body is θ, and the angle θ is, for example, related to the length and width of the vehicle, the speed of the vehicle, and weather conditions. For example, an engineering vehicle or a heavy truck of a large size may have a wider hazardous space and therefore have a larger angle θ. For example, in windy weather, the angle θ should be set to be larger to achieve a larger detection range. In some embodiments, the distance from the outer boundary of the third sub-zone 2413 to the vehicle is s multiplied by (1+margin), for example, the margin may be 50% to 200%.

As shown in FIG. 5, the boundary between the first sub-zone 2411 and the second sub-zone 2412 is defined as a first boundary, the boundary between the second sub-zone 2412 and the third sub-zone 2413 is defined as a second boundary, and the outer boundary of the third sub-zone 2413 is defined as a third boundary. Therefore, the distance from the first boundary to the second object 262 is D1, the distance between the first boundary and the second boundary is D2, and the distance between the second boundary and the third boundary is D3. For example, D1=v²/\sqrt{2 μg}, D2=s−v²/\sqrt{2 μg}=n*v−v²/\sqrt{2 μg}, and D3=0.5*s to 2*s.

In some embodiments, in response to the detection that the first threat is in the first sub-zone 2411, a notification of a first urgency level may be sent to the second object 262; in response to the detection that the first threat is in the second sub-zone 2412, a notification of a second urgency level may be sent to the second object 262; and in response to the detection that the first threat is in the third sub-zone 2413, a notification of a third urgency level may be sent to the second object 262. For example, the urgency degrees of the first urgency level, the second urgency level, and the third urgency level descend gradually. In some embodiments, the first sub-zone 2411 corresponds to a notification of the first urgency level, and the notification may correspond to an urgent warning. For example, its maximum radius D1 is the braking distance of the vehicle, a collision will become inevitable within the distance, and therefore, the first sub-zone 2411 is a situation that the vehicle must avoid. For example, when it is detected that the first object 261 is in the second sub-zone 2312, near the first boundary but has not yet fallen into the first sub-zone 2411, an urgent warning (the notification of the first urgency degree) should be issued to remind the second object 262 in advance to avoid further approaching the first object 261.

In some embodiments, the second sub-zone 2412 corresponds to a notification of the second urgency level, and the notification corresponds to a collision warning. In the traveling direction x2 of the second object 262, the minimum distance from the second sub-zone 2412 to the second object 262 corresponds to the first boundary, which is the braking distance of the second object 262, and the maximum distance corresponds to the second boundary. For example, when it is detected that the first object 261 is in the second sub-zone 2412, a collision warning (the notification of the second urgency level) may be issued to remind the driver of the second object 262 to be vigilant to avoid a collision. For example, D2 may also be related to the length and width of the vehicle, the speed of the vehicle, and weather conditions.

In some embodiments, the third sub-zone 2413 corresponds to a notification of the third urgency level, and the notification corresponds to a presence notification. For example, D3 may be much larger than D2, for example, D3 may be equal to 0.5 to 2 times D2. For example, D3 may be used to provide a rough warning and/or may provide an early warning for a specific VRU within the distance, and the specific VRU may include a pregnant woman, a pedestrian with limited mobility, a pedestrian with a child, a pedestrian pushing a stroller, or the like.

In some embodiments, the near edge continuously updates the first boundary and the second boundary as the vehicle moves, for dynamically adjusting the three sub-zones to provide the latest and accurate information. For the collision zone, the near edge dynamically calculates the braking distance of each vehicle, and the sector-shaped zone corresponding to the collision zone is exported based on the first, second, and third boundaries D1, D2, D3, and the angle θ of each vehicle. The shape of the sector-shaped zone may vary according to different vehicle categories (such as regular vehicles and trucks), and may also be dynamically adjusted based on environmental changes (such as weather and time).

FIG. 6 shows a schematic diagram illustrating an implementation of a process for threat notification in a second application scenario 242 according to some embodiments of the present disclosure. In some embodiments, detecting the first threat includes determining the second zone (monitoring zone) 2421 associated with the road in the second application scenario 242, wherein the second zone 2421 has the first threat indicating the presence of a threatening road participant. In some embodiments, the first threat may include at least one of a large vehicle and a speeding vehicle. For example, the first threat may include a large vehicle such as a crane, a mixer, an excavator, and a tractor. For example, the first threat may also include a speeding vehicle or a speeding motorcycle rider, an electric bicycle rider, and the like.

In some embodiments, sending the notification about the first threat to at least one of the first object 261 and the second object 262 associated with the first object 261 includes: sending, in response to detection of the first threat, the notification about the first threat to at least one of the first object 261 and the second object 262 located in the second zone 2421.

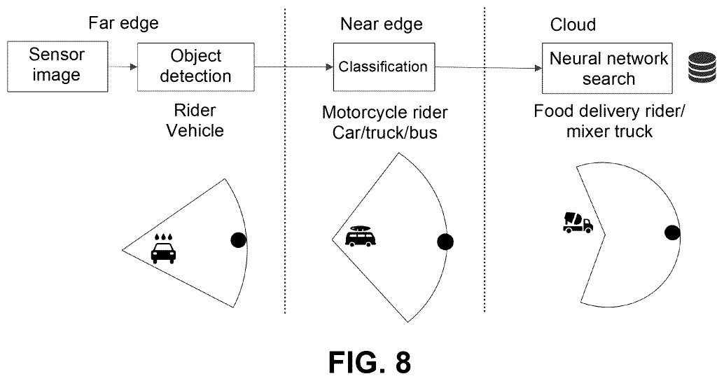

For example, the monitoring zone corresponds to a zone where vehicles or VRUs should be notified. For example, in the embodiment of FIG. 6, a square zone at an intersection represents a high-risk zone for traffic accidents and may be considered a monitoring zone. It should be understood that the monitoring zone may cover various shapes of accident prone zones, such as square, rectangular, circular, or elliptical zones near intersections, ramps, sharp turns, or other accident black spots. It should be understood that any detected hazardous material or event in the monitoring zone or near the monitoring zone, such as a mixer truck or a speeding motorcycle rider, should be notified to all road participants in the monitoring zone for protection. In some embodiments, as shown in FIG. 6, an RSU 2422 captures images of the monitoring zone and near the monitoring zone, and detects and tracks objects in the images. Once it is determined that a vehicle 2423 exceeding a safe speed is approaching the second zone 2421, and the braking distance of the vehicle 2423 is greater than its distance from the boundary of the second zone 2421, in other words, the vehicle 2423 is a threat associated with the first object 261 and the second object 262, a notification about the vehicle 2423 is sent to the first object 261 and/or the second object 262 in the second zone 2421. In some embodiments, when any one of the first object 261 and the second object 262 is a VRU, the notification about the vehicle 2423 may be sent to the wearable device of the VRU for easy viewing, and the sending speed of the notification will be faster than that of a mobile phone. In some embodiments, the notification may be sent to a VRU different from the first object 261 and the second object 262, where the VRU is also located in the second zone. In some embodiments, common deep learning practices such as image classification, object detection, and semantic segmentation may be applied in the monitoring zone to detect and classify objects in intersections. The process of object detection and classification will be described in detail with reference to FIG. 8. In some embodiments, the threat in the monitoring zone or near the monitoring zone is not very urgent, and therefore the notification about the threat may be issued as a presence notification.

FIG. 7 shows a schematic diagram of another application scenario 700 in which threat notification is implemented according to some embodiments of the present disclosure. As can be seen, an application scenario 700 includes both the first application scenario 241 and the second application scenario 242. Therefore, all the processes and steps described above in FIG. 4 to FIG. 6 about the first application scenario 241 and the second application scenario 242 may be applied to the application scenario 700.

In some embodiments, for the second object 262, the threat associated with the first object 261 is detected in the first zone (collision zone) 2410, and thus a first notification associated with the threat may be sent to the second object 262. At the same time, the threat associated with the speeding vehicle 2423 is detected in the second zone 2421, and thus a second notification associated with the threat may be sent to the second object 262. Therefore, the second object 262 may receive both the first notification and the second notification. Similar to the embodiments shown in FIG. 4 to FIG. 5 above, depending on the distance from the first object 261 to the second object 262, the first notification may be an urgent warning (the notification of the first urgency degree), a collision warning (the notification of the second urgency level), or a presence notification (the notification of the third urgency level). Similar to the embodiment shown in FIG. 6 above, the second notification may be a presence notification. Similar to the second object 262, the first object 261 may receive both the first notification associated with the second object 262 and the second notification associated with the speeding vehicle 2423. In some embodiments, the notification may be sent to a VRU different from the first object 261 and the second object 262, where the VRU is also located in the second zone 2421. In the embodiment of FIG. 7, unlike the first object 261 and the second object 262, it may be a pedestrian carrying a child, a wheelchair user, and a pedestrian leaning on a cane.

In some embodiments, two types of zones are defined for different levels of warnings to detect potential threats: a monitoring zone and a collision zone. The monitoring zone represents a zone that road participants should pay attention to even if there is no urgent threat. The collision zone represents a zone where the vehicle may potentially collide with the VRU based on the current movement trend, and there may be an urgent threat in the collision zone. For example, based on the urgency degrees in the above two zones, threats are classified into two types: presence notification and collision warning. For example, the presence notification is mainly used for early warning of a threat and is applicable to a situation in the monitoring zone and a D3 situation in the collision zone. For example, the collision warning is used for providing immediate warning of a threat and is typically used in a situation where there is a potential collision, such as a D2 situation in the collision zone.

In some embodiments, in the collision zone, a notification about a threat may be sent using a unicast method, and in the monitoring zone, a notification about a threat may be sent using a multicast method. It should be understood that the multicast method considers a specific road participant, such as a vehicle and a VRU located only in the monitoring zone, and therefore, the sent notification is more relevant and accurate.

FIG. 8 shows a schematic diagram of a process of detecting objects in an image and performing hierarchic classification on the objects according to some embodiments of the present disclosure. As shown in FIG. 8, in order to detect threats associated with the presence notification and the collision warning, various machine learning models will be utilized for object detection, classification, or segmentation, and these models will be deployed across the far edge, the near edge, and the cloud based on their computing and storage capabilities. It should be understood that the near edge is closer to the cloud than the far edge.

For example, at the far edge, an object detection model will be used to detect an object and provide a rough category, such as a vehicle or a rider. Subsequently, near the near edge, a classification model may be used to obtain more detailed information about the object, such as its specific type (refined category), such as a “truck.” If more detailed information is needed, a neural search may be performed in the cloud to query relevant object information, thereby generating fine-grained classification, such as a “mixer truck.”

In addition, as the classification becomes more specific, the monitoring zone may be dynamically updated accordingly. For example, at the near edge, if the object is classified as a truck, a monitoring angle may be set to 90 degrees. However, in the cloud, if the truck is further identified as a more dangerous mixer truck, the angle may be expanded to 135 degrees to cover a wider zone.

FIG. 9A and FIG. 9B respectively show schematic diagrams of processes for object detection and for marking an ID of an object in an image according to some embodiments of the present disclosure. In some embodiments, object detection and object tracking may be performed at the far edge and near edge, respectively. In some embodiments, the object detection shown in FIG. 9A may correspond to the block 220 in FIG. 2, and the marking of the ID shown in FIG. 9B may correspond to the block 232 in FIG. 2. In some embodiments, object detection is used for identifying a vehicle and a VRU on the road. If any one of the vehicle and the VRU is found in the image, sensor data associated with the image will be sent to the near edge for further processing. For example, the object detection serves as a trigger for subsequent processing or filtering of related content. In order to optimize bandwidth usage and computing resources, in some cases, only a specific image zone is retained for processing. For example, considering the computing power of a far edge system, an algorithm such as YoloV3-tiny may be used for object detection.

In some embodiments, object tracking will be performed in the near edge by using an algorithm such as deep classification. For example, the object tracking involves identifying a unique ID of an object in the image and determining its motion trajectory, including location, speed, and traveling direction. As shown in FIG. 9B, various vehicles and VRUs on the road are labeled with unique IDs. By calculating the coordination and prediction of these vehicles and VRUs at different times, their driving trajectories may be easily tracked.

FIG. 10 shows a schematic diagram of a process for mapping an ID of an object in an image to an ID of the object in a communication layer according to some embodiments of the present disclosure. In some embodiments, the object detection shown in FIG. 9A may correspond to the block 251 in FIG. 2.

For objects including vehicles and VRUs in a computer vision system, in order to notify a vehicle with a real transmission message, a connection between the vehicle in the computer vision system and the vehicle in the real C-V2X communication system needs to be established. FIG. 10 illustrates an architecture of ID mapping performed between two systems by using a method such as GPS and license plate recognition. An MEC APP may ultimately connect an MEC UE ID (the ID of the object in the communication layer) to the ID of the vehicle or VRU identified through object detection or object tracking. Various methods may be used to comprehensively mark UE IDs.

In some embodiments, license plate recognition may be used to indicate the UE IDs. The license plate recognition is a direct method that utilizes an optical character recognition (OCR) algorithm to recognize a license plate number of a vehicle. Then, the information may be used as a reference for retrieving its application attributes (UE ID, application session) in the MEC system. However, the method has limitations, for example, a license plate may be covered or blurred, and the method cannot be applied to pedestrians.

In other embodiments, base station positioning may be used to mark UE IDs. In the base station positioning method, the communication system has provided a UE with sufficiently accurate positioning information, with sub-meter-level accuracy in version 16 of the 3GPP communication protocol, and further enhanced to accuracy of tens of centimeters and end-to-end waiting time of less than 100 milliseconds in version 17.

Based on camera GPS coordination and vehicle offset in the image, a true location of each object in the sensor image may be calculated. Then, it may be found that the nearest UE in the MEC system connects the object in the image to the UE in the MEC system. The ID connection may be determined by comprehensively considering some deviations in trajectory data such as location, speed, and traveling direction. The UE ID in the MEC system may be retrieved through an MEC service API MEC013 Location API and an MEC014 UE Identity API. Other MEC service APIs that may be used include, for example, MEC011, MEC012, MEC015, MEC028 and MEC029, as illustrated in the figure.

The various embodiments disclosed herein provide a comprehensive user identity mapping solution for connecting the computer vision and a UE in a MEC system, thereby achieving seamless integration between the two systems for message communication.

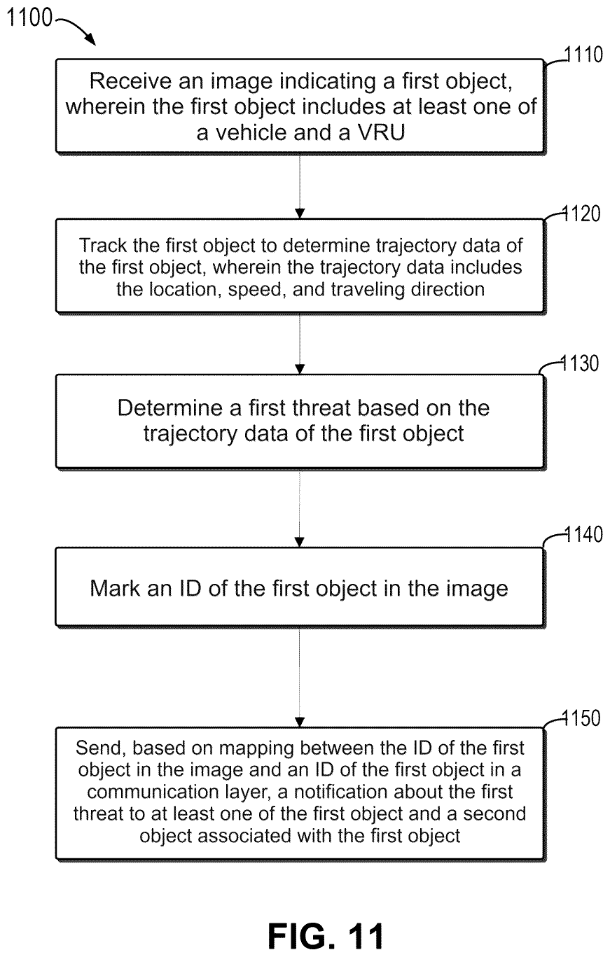

FIG. 11 shows a flow chart of another method 1100 for threat notification according to some embodiments of the present disclosure. At block 1110, the method 1100 includes receiving an image indicating a first object, wherein the first object includes at least one of a vehicle and a VRU. At block 1120, the method 1100 includes tracking the first object to determine trajectory data of the first object, wherein the trajectory data includes location, speed, and traveling direction of the first object. At block 1130, the method 1100 includes determining a first threat based on the trajectory data of the first object. At block 1140, the method 1100 includes marking an ID of the first object in the image. At block 1150, the method 1100 includes sending, based on a mapping between the ID of the first object in the image and an ID of the first object in a communication layer, the notification about the first threat to at least one of the first object and a second object associated with the first object.

In some embodiments, the notification sending considers specific road participants and may be implemented in an application layer, rather than in a transmission layer (communication layer), which does not send the same notification to all road participants in a cell or predetermined channel, and therefore, the sent notification is more accurate and flexible.

In some embodiments, the notification may be sent in two manners: using multicast and unicast for the monitoring zone and the collision zone respectively. When a threat is detected in the monitoring zone, messages may be sent to all road participants in the monitoring zone, while for a threat detected in the collision zone, a message may only be sent to a specific road participant in the scenario, such as at least one of a specific vehicle and a specific VRU.

In some embodiments, for the multicast method, the MEC may maintain a booking mechanism for message management and distribution. When a road participant enters the monitoring zone, the road participant may actively or passively book a notification message and automatically cancel the booking when leaving the zone. In some embodiments, different types of message categories will be defined based on vehicle and VRU types to achieve precise and efficient processing. For example, in terms of zones, example message categories may include monitoring zone, collision zone, hazardous event zone, and the like. For example, in terms of use cases, example message categories may include: VRU discovery, left turn assistance, and right turn assistance. For example, in a right turn assistance use case, users may be notified only on a right turn lane.

In some embodiments, a message queue may be used for managing message distribution and ensuring real-time delivery. For example, expired messages may be deleted from the queue to maintain the accuracy and efficiency.

The various embodiments disclosed herein may utilize a subscription multicast mechanism in the application layer for precise warning notification, which allow users to subscribe to specific message categories and receive relevant notifications in a timely manner.

In addition, the various embodiments of the present disclosure provide an end-to-end solution with a layered IT infrastructure that may work collaboratively by using the far edge, the near edge, and the cloud for VRU risk discovery in a C-V2X system, thereby being capable of implementing real-time response and efficient processing.

In addition, the various embodiments of the present disclosure may perform hierarchic zone processing on threat detection for preventing VRU collisions, where dynamic zone updates may be performed at the near edge and the cloud if hierarchic ultra-fine grained classification of risks is required.

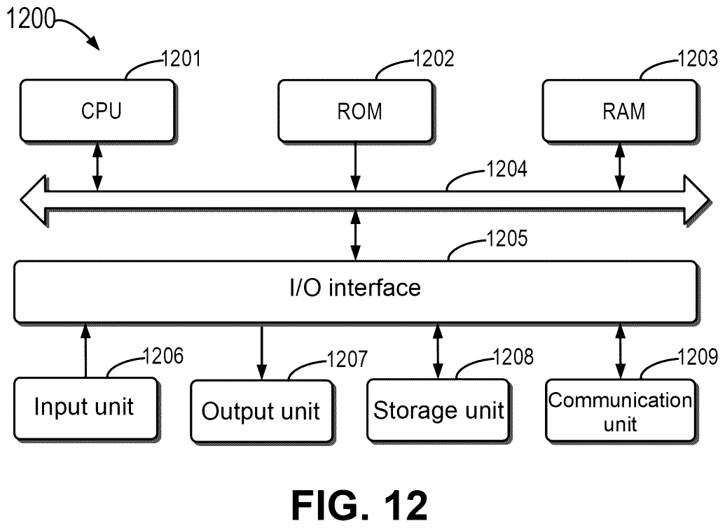

FIG. 12 shows a schematic block diagram of an example device 1200 that may be used for implementing embodiments of the present disclosure. As shown in the figure, the device 1200 includes a computing unit 1201 that may perform various appropriate actions and processing according to computer program instructions stored in a read-only memory (ROM) 1202 or computer program instructions loaded from a storage unit 1208 to a random access memory (RAM) 1203. In the RAM 1203, various programs and data required for operations of the device 1200 may also be stored. The computing unit 1201, the ROM 1202, and the RAM 1203 are connected to each other through a bus 1204. An input/output (I/O) interface 1205 is also connected to the bus 1204.

A plurality of components in the device 1200 are connected to the I/O interface 1205, including: an input unit 1206, such as a keyboard and a mouse; an output unit 1207, such as various types of displays and speakers; the storage unit 1208, such as a magnetic disk and an optical disc; and a communication unit 1209, such as a network card, a modem, and a wireless communication transceiver. The communication unit 1209 allows the device 1200 to exchange information/data with other devices over a computer network such as the Internet and/or various telecommunication networks.

The computing unit 1201 may be various general-purpose and/or special-purpose processing components with processing and computing capabilities. Some examples of the computing unit 1201 include, but are not limited to, a central processing unit (CPU), a graphics processing unit (GPU), various specialized artificial intelligence (AI) computing chips, various computing units for running machine learning model algorithms, a digital signal processor (DSP), and any appropriate processor, controller, microcontroller, and the like, although the computing unit 1201 is illustrated in the figure as comprising a CPU, by way of example. The computing unit 1201 performs various methods and processes described above, such as the method 300. For example, in some embodiments, the method 300 may be implemented as a computer software program that is tangibly included in a machine-readable medium such as the storage unit 1208. In some embodiments, part of or all the computer program may be loaded and/or installed to the device 1200 via the ROM 1202 and/or the communication unit 1209. When the computer program is loaded to the RAM 1203 and executed by the computing unit 1201, one or more steps of the method 300 described above may be performed. Alternatively, in other embodiments, the computing unit 1201 may be configured to perform the method 300 in any other suitable manner (such as by means of firmware).

The functions described herein above may be performed at least in part by one or more hardware logic components. For example, and without limitation, illustrative types of available hardware logic components include: a Field Programmable Gate Array (FPGA), an Application Specific Integrated Circuit (ASIC), an Application Specific Standard Product (ASSP), a System on Chip (SOC), a Complex Programmable Logic Device (CPLD), and the like.

Program code for implementing the method of the present disclosure may be written by using one programming language or any combination of a plurality of programming languages. The program code may be provided to a processor or controller of a general purpose computer, a special purpose computer, or another programmable data processing apparatus, such that the program code, when executed by the processor or controller, implements the functions/operations specified in the flow charts and/or block diagrams. The program code may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include one or more wire-based electrical connections, a portable computer diskette, a hard disk, a RAM, a ROM, an erasable programmable read-only memory (EPROM or flash memory), an optical fiber, a portable compact disc read-only memory (CD-ROM), an optical storage device, a magnetic storage device, or any suitable combinations thereof. Additionally, although operations are depicted in a particular order, this should be understood that such operations are required to be performed in the particular order shown or in a sequential order, or that all illustrated operations should be performed to achieve desirable results. Under certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single implementation. Conversely, various features that are described in the context of a single implementation may also be implemented in a plurality of implementations separately or in any suitable sub-combination.

Although the present subject matter has been described using a language specific to structural features and/or method logical actions, it should be understood that the subject matter defined in the appended claims is not necessarily limited to the particular features or actions described above. Rather, the specific features and actions described above are merely example forms of implementing the claims.

What is claimed is:

1. A method for threat notification, comprising:
receiving an image indicating a first object, wherein the first object comprises at least one of a vehicle and a vulnerable road user (VRU);
detecting a first threat associated with the first object based on processing of the image; and
sending, in response to detection of the first threat, a notification about the first threat to at least one of the first object and a second object associated with the first object.

2. The method according to claim 1, wherein detecting the first threat associated with the first object comprises:
tracking the first object to determine trajectory data of the first object, wherein the trajectory data comprises location, speed, and traveling direction of the first object; and
determining the first threat based on the trajectory data of the first object.

3. The method according to claim 2,
wherein detecting the first threat associated with the first object comprises:
marking an identity (ID) of the first object in the image,
and wherein sending the notification about the first threat to at least one of the first object and the second object associated with the first object comprises:
sending, based on a mapping between the ID of the first object in the image and an ID of the first object in a communication layer, the notification about the first threat to at least one of the first object and the second object associated with the first object.

4. The method according to claim 1, wherein detecting the first threat associated with the first object comprises:
determining, in a first application scenario, a first zone where the first threat exists, the first zone being associated with the second object, wherein the first zone is in a traveling direction of the second object and is a sector-shaped zone centered on the second object, and wherein the first zone is a collision zone.

5. The method according to claim 4, wherein the first zone is divided into a plurality of sub-zones according to a distance from the second object, and wherein sending the notification about the first threat to at least one of the first object and the second object associated with the first object comprises:
sending, according to a detection that the first threat is in a corresponding sub-zone, a corresponding notification to at least one of the first object and the second object associated with the first object.

6. The method according to claim 5, wherein the plurality of sub-zones comprise a first sub-zone, a second sub-zone, and a third sub-zone, and wherein a distance from a boundary between the first sub-zone and the second sub-zone to the second object is determined according to a braking distance of the second object, and a distance from a boundary between the second sub-zone and the third sub-zone to the second object is determined according to a speed and a reaction time of the second object.

7. The method according to claim 6, wherein sending the notification about the first threat to at least one of the first object and the second object associated with the first object comprises:
sending, in response to detection that the first threat is in the first sub-zone, a notification of a first urgency level to at least one of the first object and the second object associated with the first object;
sending, in response to detection that the first threat is in the second sub-zone, a notification of a second urgency level to at least one of the first object and the second object associated with the first object; and
sending, in response to detection that the first threat is in the third sub-zone, a notification of a third urgency level to at least one of the first object and the second object associated with the first object, wherein urgency degrees of the first urgency level, the second urgency level, and the third urgency level descend gradually.

8. The method according to claim 1,
wherein detecting the first threat associated with the first object comprises:
determining, in a second application scenario, a second zone associated with a road, the second zone having the first threat indicating a threatening road participant, wherein the second zone is a monitoring zone, and the first threat comprises at least one of a large vehicle and a speeding vehicle;
and wherein sending the notification about the first threat to at least one of the first object and the second object associated with the first object comprises:
sending, in response to detection of the first threat, the notification about the first threat to at least one of the first object and the second object located in the second zone.

9. The method according to claim 8, wherein the second object comprises a vehicle, and the method further comprises:
sending the notification to a VRU different from the first object and the second object, wherein the VRU is located in the second zone.

10. The method according to claim 1, wherein the image is captured by at least one of a roadside unit (RSU) and a sensor of the second object, and preprocessed to indicate the first object.

11. An electronic device, comprising:
at least one processor; and
a memory coupled to the at least one processor and having instructions stored therein, wherein the instructions, when executed by the at least one processor, cause the electronic device to perform actions comprising:
receiving an image indicating a first object, wherein the first object comprises at least one of a vehicle and a vulnerable road user (VRU);
detecting a first threat associated with the first object based on processing of the image; and
sending, in response to detection of the first threat, a notification about the first threat to at least one of the first object and a second object associated with the first object.

12. The electronic device according to claim 11, wherein detecting the first threat associated with the first object comprises:
tracking the first object to determine trajectory data of the first object, wherein the trajectory data comprises location, speed, and traveling direction of the first object; and
determining the first threat based on the trajectory data of the first object.

13. The electronic device according to claim 12,
wherein detecting the first threat associated with the first object comprises:
marking an identity (ID) of the first object in the image,
and wherein sending the notification about the first threat to at least one of the first object and the second object associated with the first object comprises:
sending, based on a mapping between the ID of the first object in the image and an ID of the first object in a communication layer, the notification about the first threat to at least one of the first object and the second object associated with the first object.

14. The electronic device according to claim 11, wherein detecting the first threat associated with the first object comprises:
determining, in a first application scenario, a first zone where the first threat exists, the first zone being associated with the second object, wherein the first zone is in a traveling direction of the second object and is a sector-shaped zone centered on the second object, and wherein the first zone is a collision zone.

15. The electronic device according to claim 14, wherein the first zone is divided into a plurality of sub-zones according to a distance from the second object, and wherein sending the notification about the first threat to at least one of the first object and the second object associated with the first object comprises:
sending, according to a detection that the first threat is in a corresponding sub-zone, a corresponding notification to at least one of the first object and the second object associated with the first object.

16. The electronic device according to claim 15, wherein the plurality of sub-zones comprise a first sub-zone, a second sub-zone, and a third sub-zone, and wherein a distance from a boundary between the first sub-zone and the second sub-zone to the second object is determined according to a braking distance of the second object, and a distance from a boundary between the second sub-zone and the third sub-zone to the second object is determined according to a speed and a reaction time of the second object.

17. The electronic device according to claim 16, wherein sending the notification about the first threat to at least one of the first object and the second object associated with the first object comprises:
sending, in response to detection that the first threat is in the first sub-zone, a notification of a first urgency level to at least one of the first object and the second object associated with the first object;
sending, in response to detection that the first threat is in the second sub-zone, a notification of a second urgency level to at least one of the first object and the second object associated with the first object; and
sending, in response to detection that the first threat is in the third sub-zone, a notification of a third urgency level to at least one of the first object and the second object associated with the first object, wherein urgency degrees of the first urgency level, the second urgency level, and the third urgency level descend gradually.

18. The electronic device according to claim 11,
wherein detecting the first threat associated with the first object comprises:
determining, in a second application scenario, a second zone associated with a road, the second zone having the first threat indicating a threatening road participant, wherein the second zone is a monitoring zone, and the first threat comprises at least one of a large vehicle and a speeding vehicle;
and wherein sending the notification about the first threat to at least one of the first object and the second object associated with the first object comprises:
sending, in response to detection of the first threat, the notification about the first threat to at least one of the first object and the second object located in the second zone.

19. The electronic device according to claim 18, wherein the second object comprises a vehicle, and the actions further comprise:
sending the notification to a VRU different from the first object and the second object, wherein the VRU is located in the second zone.

20. A computer program product, the computer program product being tangibly stored on a non-volatile computer-readable medium and comprising machine-executable instructions, wherein the machine-executable instructions, when executed by a machine, cause the machine to perform actions comprising:
receiving an image indicating a first object, wherein the first object comprises at least one of a vehicle and a vulnerable road user (VRU);
detecting a first threat associated with the first object based on processing of the image; and
sending, in response to detection of the first threat, a notification about the first threat to at least one of the first object and a second object associated with the first object.
